(19) United States
(12) Patent Application Publication
(10) Pub. No.: US 2022/0008762 A1
(43) Pub. Date: Jan. 13, 2022

(54) Antibacterial and Cellphone Radiation-proof Face Mask

(71) Applicant: Dana Rubin, Calabasas, CA (US)

(72) Inventor: Dana Rubin, Calabasas, CA (US)

(21) Appl. No.: 17/372,170

(22) Filed: Jul. 9, 2021

Related U.S. Application Data
(60) Provisional application No. 63/049,984, filed on Jul. 9, 2020.

(51) Int. Cl. A62B 18/02; A41D 13/11; H05F 1/00

(52) U.S. Cl. CPC A62B 18/025; H05F 1/00; A41D 13/1192; A41D 13/1161

(57) ABSTRACT

The multilayer protective face covering device is intended to provide a dual-purpose face mask that is suitable for daily use. In other words, the device is a face mask that is capable of creating an electromagnetic barrier between a cell phone and a wearer in addition to providing an effective barrier against multiple airborne pollutants such as allergens, bacteria and viruses. To accomplish this, the device includes a plurality of layers, each being devoted to a specific function. Further, the device covers the ears and the temporal region of a user, thereby protecting vital and sensitive areas of the user's face. Furthermore, the ear and temporal region cover may be detachably attached to any existing facemask, which makes the device multifunctional and universal. Additionally, the device may include multiple fastening means for attaching to the user's face. Thus, the device is simple, efficient, inexpensive to manufacture, and easy to use.

The current application claims a priority to the U.S. Provisional Patent application Ser. No. 63/049,984 filed on Jul. 9, 2020.

### FIELD OF THE INVENTION

The present invention relates generally to personal protective equipment with radiation protection. More specifically, the present invention is a face mask that incorporates an antibacterial and electromagnetic barrier. The present invention is specifically designed for protecting a wearer from hazardous airborne substances and cell phone radiofrequency radiation. However, the present invention is not limited to this option, and it may further be adapted for different purposes.

### BACKGROUND OF THE INVENTION

Mobile or cell phones are ubiquitous today and have become an integral part of modern telecommunications in every individual's life. Cell phones emit radiofrequency energy, a form of non-ionizing electromagnetic radiation, which can be absorbed by tissues close to the phone. Studies have allegedly shown that cell phone radiation may impose some risk associated with cancer. The amount of radiofrequency energy a cell phone user is exposed to depends on many factors, such as the technology of the phone, the distance between the phone and the user, the extent and type of cell phone use and the user's distance from cell phone towers. In order to reduce cell phone radiation, many people choose to use the cell phone at a distance from their body, for example, by using a hands-free device, because power (and thus the radiofrequency exposure to a user) falls off rapidly with increasing distance. However, this requires an additional piece of equipment, which is costly and may not be easily available.

In addition, during a pandemic, such as an influenza pandemic or wide-spread outbreaks of other infectious respiratory illnesses (e.g., “COVID-19”, which stands for coronavirus disease 2019), face masks are critical to ensuring the basic health protection and safety of the wearers. However, there exist no face masks that can protect wearers from harmful effects of air pollution and electromagnetic radiation, such as radiofrequency radiation produced by cell phones, at the same time by utilizing or wearing one face mask.

It is an objective of the present invention to provide users with a device, that can solve some of these problems, by disclosing a face mask that is capable of creating an electromagnetic barrier between the cell phone and the wearer in addition to providing an effective barrier against multiple airborne pollutants such as allergens, bacteria and viruses. In other words, the present invention is a radiation-proof face mask that can be used to prevent the spread of infectious diseases (e.g., COVID-19) and protect the wearer from radiofrequency radiation emitted by cell phones. To accomplish this, the present invention comprises a plurality of layers, each being devoted to a specific function. Further, the present invention ensures that the device covers the ears and the temporal region of a user, thereby protecting vital and sensitive areas of the user's face. Furthermore, the ear and temporal region covering panels may be detachably attached to any existing facemask, which makes the present invention multifunctional and universal. Additionally, the present invention may include multiple fastening means for attaching the protective covering to the user's face. Thus, the present invention is an efficient facemask device, that is simple in structure, inexpensive to manufacture, and easy to use.

### BRIEF DESCRIPTION OF THE DRAWINGS

FIG. 1 is a perspective view illustrating the different layers of the present invention.

FIG. 2 is front perspective view illustrating a protective covering of the present invention.

FIG. 3 is a perspective view illustrating a first embodiment of the present invention.

FIG. 4 is a perspective view illustrating a second embodiment of the present invention.

FIG. 5 is a perspective view illustrating a third embodiment of the present invention.

FIG. 6 is a perspective view that illustrates the face mask of the present invention in use.

### DETAIL DESCRIPTIONS OF THE INVENTION

All illustrations of the drawings are for the purpose of describing selected versions of the present invention and are not intended to limit the scope of the present invention.

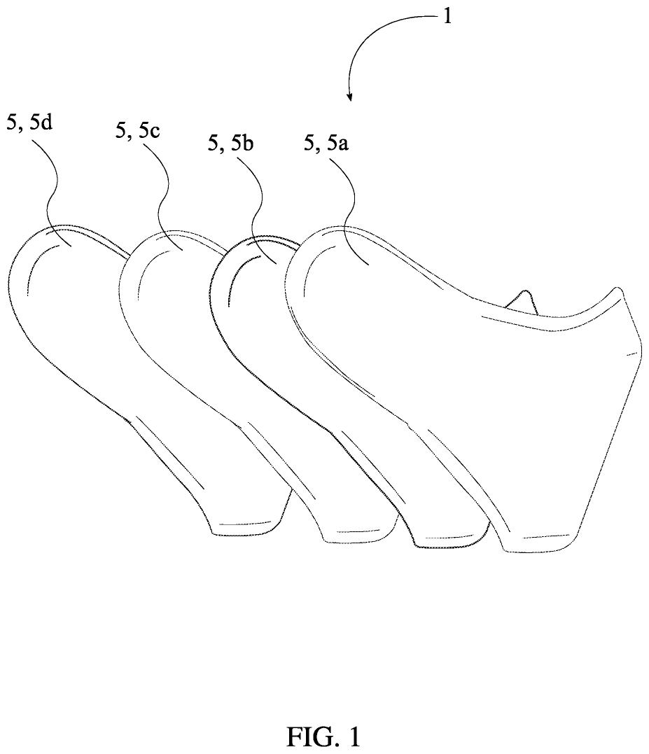

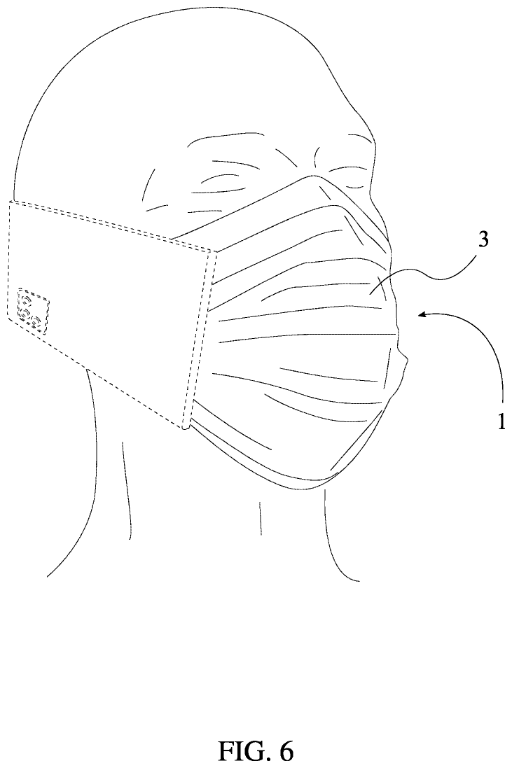

In reference to FIG. 1 through FIG. 6, the present invention is a multilayer protective facemask. It is an objective of the present invention to provide users with a device, that is capable of creating an electromagnetic barrier between the cell phone and the wearer in addition to providing an effective barrier against multiple airborne pollutants such as allergens, bacteria and viruses. In other words, the present invention is a radiation-proof face mask that may be used to prevent the spread of infectious diseases (e.g., COVID-19) and protect the wearer from radiofrequency radiation emitted by cell phones. To accomplish this, the present invention comprises a plurality of layers, each being devoted to a specific function. Further, the present invention ensures that the device covers the ears and the temporal region of a user, thereby protecting vital and sensitive areas of the user's face from electromagnetic radiation. Furthermore, the present invention comprises components that may be detachably attached to any existing facemask, which makes the present invention multifunctional and universal. Additionally, the present invention incorporates multiple fastening means for attaching the protective covering to the user's face.

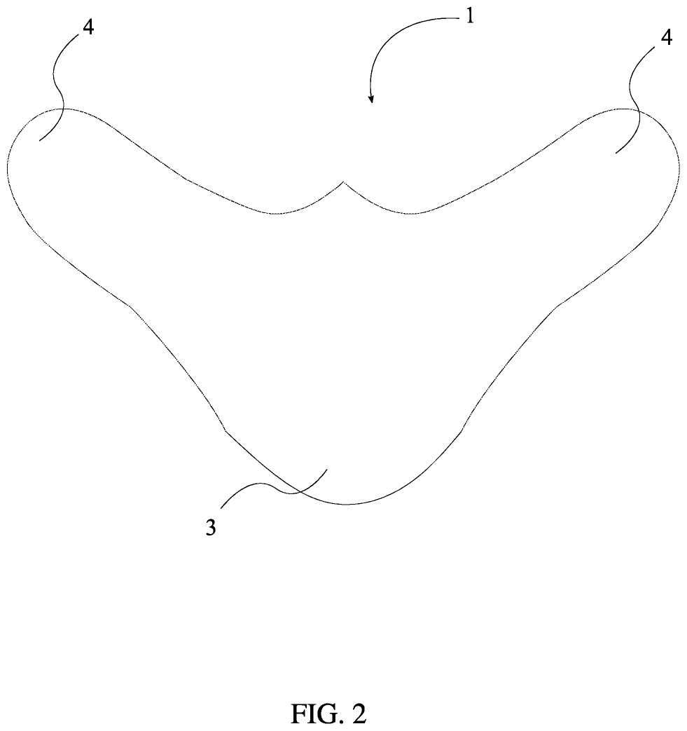

The following description is in reference to FIG. 1 through FIG. 6. According to a preferred embodiment, the present invention comprises a protective covering 1, and a plurality of fasteners 2. It is an aim of the present invention to provide a face mask that covers the wearer's ears and temple area. To accomplish this, the protective covering 1 comprises a face covering portion 3 and a plurality of ear and temporal covering portion 4. This is so that the protective covering 1 which also protects the wearer from electromagnetic radiation covers the sensitive areas on the user's face that come in contact with a phone when the user is talking over the phone. More specifically, the plurality of ear and temporal covering portion 4 covers the ears and temporal region of a user's face. Preferably, the face covering portion 3 and the plurality of ear and temporal covering portion 4 comprises a plurality of protective layers 5. The plurality of protective layers 5 works together to block airborne aerosol of hazardous biological agents (such as bacteria or viruses) and protect the wearer from electromagnetic radiation at the same time. In other words, the protective covering 1 is antibacterial, antiviral, and acts as a barrier for electromagnetic radiation. As seen in FIG. 2, in the preferred embodiment, the protective covering 1 has an extended facemask shape with regions that covers the nose, mouth, ears, temporal region etc. according to the contours of a human's face. In other words, the protective covering 1 may comprise a single layer or multi-layer of flexible, skin friendly fabric with substantially curved edges, and having dimensions big enough to cover the mouth, nose, ear and temporal region of a user. Examples of such materials include, but are not limited to woven cotton, cotton/polyester blends of high tensile strength, etc. However, the protective covering 1 may comprise any number or layers, shape, size, components, and arrangement of components that are known to one of ordinary skill in the art, as long as the intents of the present invention are not altered.

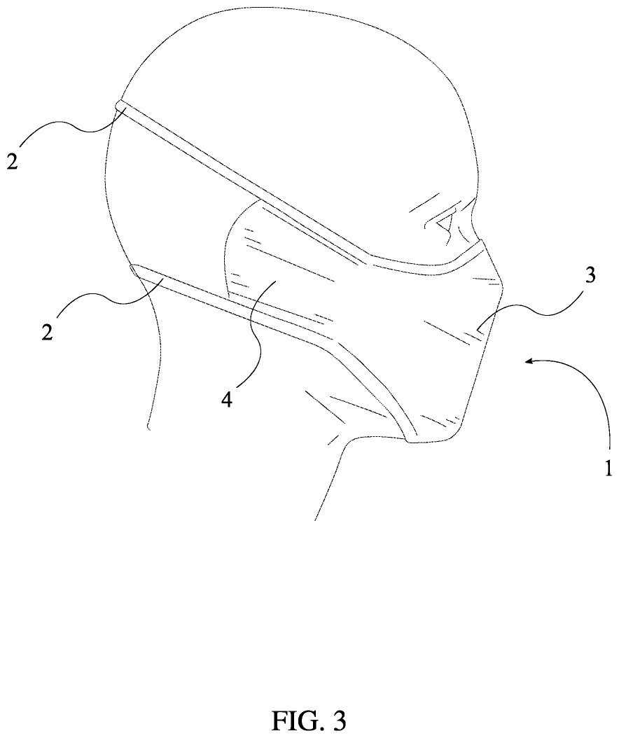

As seen in FIG. 3 through FIG. 5, each of the plurality of ear and temporal covering portion 4 is terminally mounted to at least one lateral edge 6 of the face covering portion 3. This is so that, the plurality of ear and temporal covering portion 4 and the face covering portion 3 may be connected seamlessly to cover the necessary portions of the user's face. Further, the plurality of ear and temporal covering portion 4 maybe removably attached to the face covering portion 3, such that the plurality of ear and temporal covering portion 4 may be used as an additional protective device to any existing facemasks. In another embodiment, the protective covering 1 and the plurality of layers 5 may be designed to further cover the wearer's neck.

Continuing with the preferred embodiment, and in reference to FIG. 1, the plurality of protective layers 5 comprises a first layer 5a, a second layer 5b, a third layer 5c, and a fourth layer 5d. Preferably, the first layer 5a is positioned opposite to the fourth layer 5d across the protective covering 1, the second layer 5b is positioned between the first layer 5a and the third layer 5c, and the third layer 5c is positioned between the second layer 5b and the fourth layer 5b. In the preferred embodiment, the first layer 5a is an antibacterial and electrostatic absorption layer. More specifically, the first layer 5a is an antibacterial and electrostatic absorption layer in which radiation shielding material (e.g., metal, such as silver, copper, etc.) is dispersed in a soft and pliable base material. The base material of the first layer 5a may be selected from the group consisting of the following: cotton, wool, silk, fur, leather, down, ingeo, plant-fiber, lycra, rayon, acetate, nylon, modacrylic, olefin, acrylic, polyester, polylactide, vinyon, saran, spandex, aramid, PBI, sulfar, lyocell, acrylonitrile rubber mate, etc. Due to the fact that the radiation shielding material (e.g., silver, copper, etc.) can also be used as antimicrobial and antiviral agents, the third layer 5c also helps protect the wearer from hazardous airborne substances. Further, the base material may be an antibacterial nonwoven fabric having high hydrophobicity or water repellency. In the preferred embodiment, bacteria- or virus-containing droplets adhered to the first layer 5a are prevented from being absorbed onto the first layer 5a itself and thus cannot be easily led to the intermediate layers. Moreover, the first layer 5a may have an increased air permeability to make mask wearing more comfortable for the wearer.

Continuing with the preferred embodiment, the second layer 5b is a filter layer. In other words, the second layer 5b is a filter layer formed from a filter material that can prevent particles or other contaminants from passing therethrough, while allowing an exchange of air and perhaps vapor. In a preferred embodiment, the second layer 5b may be detachable and replaceable. For example, the second layer 5b may be attached to the first layer 5a and/or the third layer 5c via hook and loop fasteners or any other suitable attachment means.

Further, the third layer 5c is an absorption layer. The third layer 5c acts as an absorption layer configured to capture any hazardous particles that have penetrated the first layer and the second layer. In a preferred embodiment, the third layer 5c is also detachable and replaceable.

Furthermore, the fourth layer 5d is a skin friendly layer. The fourth layer 5d is the inner layer that is adapted to come into direct contact with the wearer's skin, and thus should be made from a skin-friendly material, such as 100% cotton. However, it should be noted that other suitable materials are also contemplated.

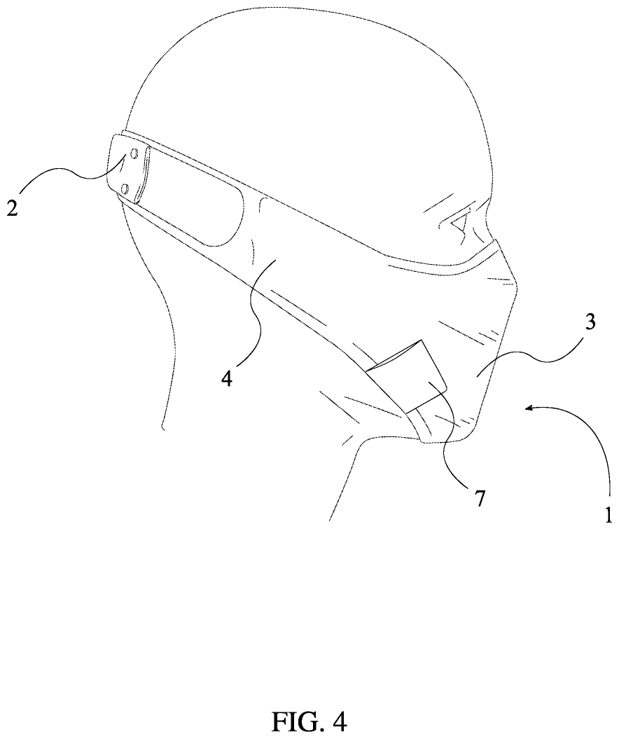

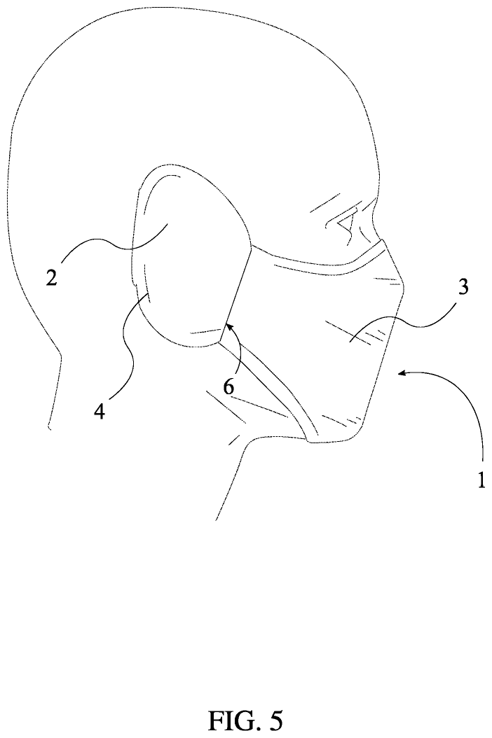

In the preferred embodiment, the plurality of fasteners 2 is mounted to terminal edges of the protective covering 1, wherein the plurality of fasteners 2 is configured to hold the face mask in place. This is so that the plurality of fasteners 2 does not hinder the functionality of the facemask, as well as does not cause any discomfort to the user's face. Preferably, the plurality of fasteners 2 is connected to the first layer 5a or fourth layer 5d. In other words, the plurality of fasteners 2 is mounted to at least one of the first layer 5a and the fourth layer 5d, such that it is easier to connect the fastener to the protective covering 1. In the preferred embodiment, the plurality of fasteners 2 may be manufactured in many forms. Examples of such fasteners include, but are not limited to elastic straps, hook and loop fasteners, snap clip, magnetic fasteners etc. FIG. 3 illustrates a first embodiment of the present invention, wherein headbands act as the plurality of fasteners. In other words, the plurality of fasteners 2 comprises headbands, as seen in FIG. 3. Similarly, FIG. 4 illustrates a second embodiment in which a leather holder is used as the securement means. In other words, the plurality of fasteners 2 comprises a leather sleeve, as seen in FIG. 4. In a third embodiment shown in FIG. 5, an earmuff is formed on the ear-covering portion of the face mask, wherein each earmuff comprises an ear receiving cavity such that the face mask does not slide down during wearing. In other words, the plurality of fasteners 2 comprises ear-muff shaped holders, as seen in FIG. 5. However, it should be noted that the plurality of fasteners 2 may comprise any other fastener kind or fastening technology that are known to one of ordinary skill in the art, as long as the objectives of the present invention are fulfilled.

In reference to FIG. 4, the present invention comprises at least one pocket 7. Preferably, the at least one pocket 7 is laterally mounted onto the protective covering 1, such that the pocket 7 is suitably located at a location that does not compromise the wearing comfort of the user. Preferably, the pocket 7 may be used to store small items that are usually carried around by the wearer (e.g., earbuds, earplugs, etc.). However, the pocket 7 may comprise any other size, shape, fastening technique, components etc., and contain anything, as long as the intents of the present invention are not altered. Thus, the present invention is an efficient facemask device, that is simple in structure, inexpensive to manufacture, and easy to use.

Although the invention has been explained in relation to its preferred embodiment, it is to be understood that many other possible modifications and variations can be made without departing from the spirit and scope of the invention.

What is claimed is:

1. A multilayer protective facemask comprising:
a protective covering;
a plurality of fasteners;
the protective covering comprising a face covering portion and a plurality of ear and temporal covering portion;
the face covering portion and each of the plurality of ear and temporal covering portion comprising a plurality of protective layers;
each of the plurality of ear and temporal covering portion being terminally mounted to a lateral edge of the face covering portion; and
the plurality of fasteners being mounted to terminal edges of the protective covering.

2. The multilayer protective facemask of claim 1, wherein the protective covering being antibacterial, antiviral, and a barrier for electromagnetic radiation.

3. The multilayer protective facemask of claim 1, wherein the plurality of ear and temporal covering portion being removably attached to the face covering portion.

4. The multilayer protective facemask of claim 1, wherein the plurality of ear and temporal covering portion covers the ears and temporal region of a user's face.

5. The multilayer protective facemask of claim 1, the plurality of protective layers comprising:
a first layer, a second layer, a third layer, and a fourth layer;
the first layer being positioned opposite to the fourth layer across the protective covering;
the second layer being positioned between the first layer and the third layer; and
the third layer being positioned between the second layer and the fourth layer.

6. The multilayer protective facemask of claim 5, comprising:
the first layer being an antibacterial and electrostatic absorption layer;
the second layer being a filter layer;
the third layer being an absorption layer; and
the fourth layer being a skin friendly layer.

7. The multilayer protective facemask of claim 5, wherein the plurality of fasteners being mounted to at least one of the first layer and the fourth layer.

8. The multilayer protective facemask of claim 1, wherein the plurality of fasteners comprising a leather sleeve.

9. The multilayer protective facemask of claim 1, wherein the plurality of fasteners comprising ear-muff shaped holders.

10. The multilayer protective facemask of claim 1, wherein the plurality of fasteners comprising headbands.

11. The multilayer protective facemask of claim 1, comprising:
at least one pocket; and
the pocket being laterally mounted onto the protective covering.

12. A multilayer protective facemask comprising:
a protective covering;
a plurality of fasteners;
the protective covering comprising a face covering portion and a plurality of ear and temporal covering portion, wherein the protective covering being antibacterial, antiviral, and a barrier for electromagnetic radiation;
the face covering portion and each of the plurality of ear and temporal covering portion comprising a plurality of protective layers;
each of the plurality of ear and temporal covering portion being terminally mounted to a lateral edge of the face covering portion; and
the plurality of fasteners being mounted to terminal edges of the protective covering.

13. The multilayer protective facemask of claim 12, wherein the plurality of ear and temporal covering portion being removably attached to the face covering portion.

14. The multilayer protective facemask of claim 12, the plurality of protective layers comprising:
a first layer, a second layer, a third layer, and a fourth layer;
the first layer being positioned opposite to the fourth layer across the protective covering;
the second layer being positioned between the first layer and the third layer; and
the third layer being positioned between the second layer and the fourth layer.

15. The multilayer protective facemask of claim 14, comprising:
the first layer being an antibacterial and electrostatic absorption layer;
the second layer being a filter layer;
the third layer being an absorption layer; and
the fourth layer being a skin friendly layer.

16. The multilayer protective facemask of claim 14, wherein the plurality of fasteners being mounted to at least one of the first layer and the fourth layer.

17. The multilayer protective facemask of claim 12, wherein the plurality of fasteners comprising a leather sleeve.

18. The multilayer protective facemask of claim 12, wherein the plurality of fasteners comprising ear-muff shaped holders.

19. The multilayer protective facemask of claim 12, wherein the plurality of fasteners comprising headbands.
